(19) United States
(12) Patent Application Publication
(10) Pub. No.: US 2005/0002456 A1
(43) Pub. Date: Jan. 6, 2005

(54) Motion vector detector for frame rate conversion and method thereof

(76) Inventor: Jong-sul Min, Hwaseong-si (KR)

Correspondence Address: STANZIONE & KIM, LLP, 1740 N STREET, N.W., FIRST FLOOR, WASHINGTON, DC, 20036, US

(21) Appl. No.: 10/844,348

(22) Filed: May 13, 2004

(30) Foreign Application Priority Data
Jul. 4, 2003 (KR) 2003-45390

(51) Int. Cl. H04N 7/12

(52) U.S. Cl. 375/240.16; 375/240.12; 375/240.24

(57) ABSTRACT

An apparatus for and a method of detecting a motion vector (MV) by selectively using a median filter according to a correlation between blocks in a frame rate conversion of an image signal. The apparatus includes first and second motion vector detection units. The first motion vector detection unit performs motion estimation on a reference block to detect a motion vector as a final MV of the reference block if a location of the reference block in the present frame of an input image signal belongs to an object's boundary area adjacent to an image area in which a motion scarcely exists. The second motion vector detection unit performs median-filtering the MV of the reference block to detect a medial MV as the final MV of the reference block if the location of the reference block does not belong to the object's boundary facing the area in which the motion scarcely exists. Thus, the occurrence of motion artifacts due to the median filter can be prevented.

### CROSS-REFERENCE TO RELATED APPLICATIONS

This application claims the priority of Korean Patent Application No. 2003-45390, filed on Jul. 4, 2003, in the Korean Intellectual Property Office, the disclosure of which is incorporated herein in its entirety by reference.

### BACKGROUND OF THE INVENTION

1. Field of the Invention

The present general inventive concept relates to a motion vector detector for frame rate conversion of an image signal and a method thereof, and more particularly, to an apparatus for and a method of detecting a motion vector using a median filter.

2. Description of the Related Art

Frame rate conversion of an image signal is performed to make the image signal suitable for various TV standards. In an early stage, the frame rate conversion was performed via frame repetition or by using a simple spatio-temporal filter. However, this frame rate conversion has caused motion jitter or blurring at an image border.

Thus, a method of converting a frame rate using motion compensation has been suggested. In order to compensate for a motion of an input image signal, a motion vector (MV) should be generated by estimating the motion of the input image signal.

Generally, a block matching algorithm is used for generating the MV via motion estimation. That is, the most concurrent block with respect to a reference block of a present frame is detected by shifting the reference block of the present frame into a motion locus direction within a searching scope of a previous frame, and a difference in locations of the reference block and the detected block is generated as the MV. A method of detecting a mean absolute error (MAE) to get a minimum error between blocks is used for detecting the most concurrent block of the previous frame with respect to the reference block of the present frame.

When the MV has an error, however, a normal motion compensation cannot be obtained. Thus, a conventional method of converting the frame rate uses a median filter to minimize the error of the MV.

That is, if the MVs are obtained with respect to all blocks in the present frame, an MV of a reference block of the present frame and the MVs of the surrounding blocks of the reference block of the present frame are called (arranged). For example, a motion vector MV4 of the reference block E and motion vectors MV0, MV1, MV2, MV3, MV5, MV6, MV7, and MV8 of the surrounding blocks A, B, C, D, F, G, H, and I are called (arranged) as shown in FIG. 1. The median filter sequentially arrays values from the MV0 to the MV8 to detect an MV having a mean value as the MV of the reference block E.

The median filter has an excellent effect in reducing the errors of the MV, particularly in a case of an image or a character having large motion and repetition, according to a correlation with the surrounding blocks.

However, when the median filter is applied to detect the MV at an object's boundary adjacent to an area in which a motion scarcely exists, such as a background, motion artifacts like a broken image occur due to wrong (inaccurate) MVs obtained by the median filter. That is, as shown in FIGS. 2A and 2B, the image is broken at the object's boundary next to the background.

This phenomenon may happen when a difference between a value of the MV of the surrounding blocks and a value of the MV of the object's boundary next to the area in which a motion scarcely exists, is large.

### SUMMARY OF THE INVENTION

In order to solve the foregoing and/or other problems, it is an aspect of the present general inventive concept to provide an apparatus for and method of detecting a motion vector (MV) by selectively using a median filter based on a correlation between blocks when a frame rate is converted.

In order to solve the foregoing and/or other problems, it is an aspect of the present general inventive concept to provide an apparatus for and a method of stably detecting a motion vector at an object's boundary adjacent to an area in which a motion scarcely exists when a frame rate is converted.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a motion vector detector including a first motion vector detector unit to detect a first motion vector detected by motion estimation on a reference block as a final motion vector of the reference block if the reference block in a present frame is located in an object's boundary area adjacent to an image area in which motion scarcely exists, and a second motion vector detector unit to detect a second motion vector obtained by median-filtering the first motion vector as the final motion vector of the reference block if the reference block is not located in the object's boundary area adjacent to the image area in which motion scarcely exists.

The foregoing and/or other aspects of the present general inventive concept may also be achieved by providing a motion vector detector including a motion estimation unit to estimate a motion vector and a mean absolute error value corresponding to the motion vector with respect to a predetermined block using a previous frame and a present frame, a storage unit to store the motion vectors and mean absolute error values estimated by the motion estimation unit, a mean absolute error variance value calculator to calculate a mean absolute error variance value of a reference block of the present frame, a median filter to perform median-filtering on the motion vector of the reference block, and a selection unit to select one of a signal output from the median filter and the motion vector of the reference block stored in the storage unit and to output the selected one as a final motion vector of the reference block, based on the mean absolute error variance value.

The foregoing and/or other aspects of the present general inventive concept may also be achieved by providing a method of detecting a motion vector, the method including detecting a motion vector and a mean absolute error corresponding to the motion vector with respect to a predetermined block using a previous frame storing the detected motion vector and the detected motion absolute error, calculating a mean absolute error variance value of a reference block of the present frame, detecting a median-filtering result on the Motion vector of the reference block as a final motion vector of the reference block if a location of the reference block does not belong to an object's boundary area adjacent to an image area in which a motion scarcely exists, based on the mean absolute error variance value, and detecting the stored motion vector of the reference block as the final motion of the reference block if the location of the reference block belongs to the object's boundary area adjacent to the image area in which motion scarcely exists.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view showing motion vectors (MVs) corresponding to block in order to explain a conventional median-filtering;

FIGS. 2A and 2B views showing examples of images detected a wrong MV by using a median filter;

FIG. 3 is a block diagram showing a motion vector detector according to an embodiment of the present general inventive concept;

FIG. 4 is a view showing a mean absolute error (MAE) of blocks used in a MAE variance value calculator in FIG. 3;

FIG. 5 is a flow chart showing a method of detecting a MV according to another embodiment of the present general inventive concept;

FIG. 6A is a view showing examples of image signals before a median filter is applied;

FIG. 6B is a view showing examples of image signals after the median filter is applied; and

FIG. 6C is a view showing examples of image signals by selectively applying the median filter, according to another embodiment the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present invention by referring to the figures.

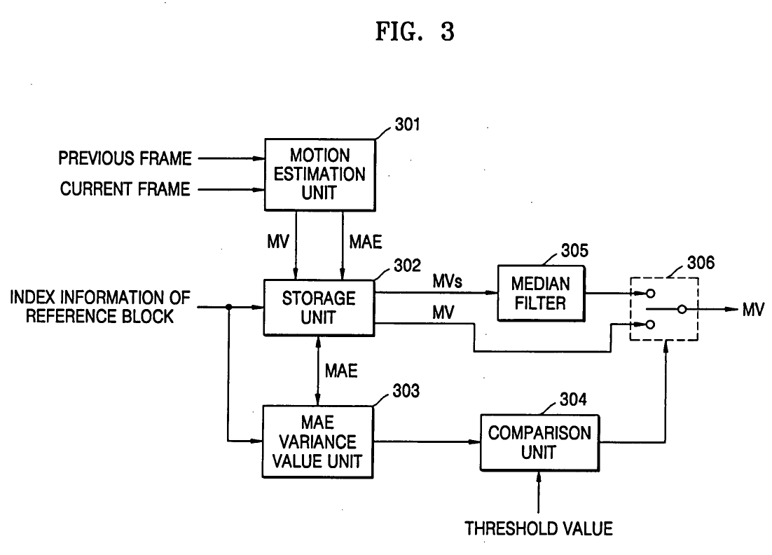

FIG. 3 a block diagram of a motion vector detector according to an embodiment of the present invention. Referring to FIG. 3, the motion vector detector may include a motion estimation unit 301, a storage unit 302, a mean absolute error (MAE) variance value calculator (MAE variance value unit) 303, a comparison unit 304, a median filter 305, and a selection unit 306.

The motion estimation unit 301 can estimate a motion of a present frame of an input image signal with respect to each predetermined block using a previous frame and the present frame of the input image signal. The size of the predetermined block can be 8×8 or 16×16 pixels. Hereinafter, a block of which motion is estimated is called a unit block, for example, a “reference block” of the present frame.

The motion estimation unit 301 can detect a motion vector (MV) and a mean absolute error (MAE) value corresponding to each reference block by estimating the motion of the reference block of the present frame. The MV is a motion vector having the least value among MAE values obtained via block matching. The MAE values corresponding to the respective unit blocks can be calculated using equation (1).

$$MAE = \frac{1}{MN} {\sum }_{i = 0}^{M - 1} {\sum }_{j = 0}^{N - 1} ( \vert {f}_{2} ( i , j ) - {f}_{1} ( i , j ) \vert ) \\ M \text{:} blockwidth , N \text{:} blockheight , \\ {f}_{1} ( i , j ) \text{:} previous frame pixel , {f}_{2} ( i , j ) \text{:} next frame pixel \qquad ( 1 )$$

After the MV and the MAE value of the present frame with respect to each predetermined block are detected, the motion estimation unit 301 can store the MV and the MAE value with respect to the predetermined block in the storage unit 302.

The storage unit 302 can store the MV and the MAE value with respect to the predetermined block. The storage unit 302 can output the MVs through two output terminals, based on index information of the reference block. That is, the storage unit 302 can output the MVs of the reference block and the surrounding blocks through one of the two output terminals and can also output the MV of the reference block through the other one of the two output terminals. The index information of the reference block can be provided from a system control unit (not shown) and can be sequentially increased via block matching.

The MAE variance value calculator 303 can read the MAE values of the reference block and the surrounding blocks of the reference block among the MAE values of the respective block units stored in the storage unit 303 when the index information on the reference block of the present frame is input. The surrounding blocks can be disposed adjacent to or around the reference block and can exist within a scope (area) to check a correlation between an image area corresponding to the reference block and a surrounding image area on a frame (field).

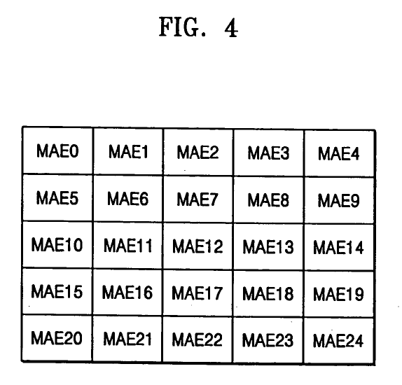

For instance, if the MAE variance value calculator 303 is designed to read the MAE values of 5×5 blocks to calculate a mean absolute value (MAE) variance value (mae_variance), and the MAE value of the reference block is MAE 12 as shown in FIG. 4, the MAE variance value calculator 303 can read twenty five MAE values, MAE 0 to MAE 24, from the storage unit 302 as shown in FIG. 4.

After the MAE values of the reference block and the surrounding blocks are read from the storage unit 302, the MAE variance value calculator 303 can calculate a mean value (mae_mean) of the MAE values according to equation (2).

$$mae\_mean = \frac{1}{M} {\sum }_{i = 0}^{M - 1} {MAE}_{i} \qquad ( 2 )$$

In the above equation (2), M is the number of surrounding blocks used for obtaining the mean value (mae_mean) of the read MAE values. Thus, in a case that the MAE values of the twenty five blocks are read as described above, the M has a value of 25. The MAE variance value (mae_variance) of the reference block can be obtained according to equation (3) using the calculated mean value (mae_mean) and the MAE values.

$$mae\_variance = {\sum }_{i = 0}^{M - 1} ( \vert {MAE}_{i} - mae\_mean \vert ) \qquad ( 3 )$$

Then, the calculated MAE variance value can be provided to the comparison unit 304.

The comparison unit 304 can compare the MAE variance value transferred from the MAE variance value calculator 303 with a predetermined threshold value. The predetermined threshold value can be used for deciding whether an image area of the reference block is an object's boundary area adjacent to an image area, in which a motion scarcely exists on a frame, such as a background. Thus, the predetermined threshold value can be set by referring to the obtained MAE variance value when the image area of the reference block is the object's boundary area. Here, it is determined that the motion scarcely exists in the image area on a frame if an amount of the motion is less than a predetermined value.

The comparison unit 304 can output a signal indicating that a location of the reference block is not within the object's boundary area if the MAE variance value is larger than the predetermined threshold value. However, the comparison unit 304 can output another signal indicating that the location of the reference block is within the object's boundary area if the MAE variance value is not larger than the predetermined critical value. The output signal from the comparison unit 304 can be provided to the selection unit 306.

The median filter 305 can perform median-filtering the MVs of the reference block and the surrounding blocks. When the index information on the reference block is input, the storage unit 302 can provide the MVs of the reference block and the surrounding blocks to the median filter 305. Then, the median filter 305 can array the MVs according to their values and can output one of the MVs as a median MV.

The selection unit 306 can selectively output the median MV output from the median filter 305 and the MV of the reference block output from the storage unit 302 as a final motion vector (final MV) of the reference block according to the signal output from the comparison unit 304.

That is, the selection unit 306 can select and output the median MV output from the median filter 305 if the signal provided from the comparison unit 304 indicates that the MAE variance value is larger than the predetermined threshold value. Accordingly, the medial MV output from the median filter 305 can be used as an actual MV (final MV) of the reference block.

The selection unit 306 can also select and output the MV of the reference block output from the storage unit 302 if the signal provided from the comparison unit 304 indicates that the MAE variance value is not larger than the predetermined threshold value. Accordingly, the MV of the reference block stored in the storage unit 302 can be used as the actual MV (the final MV) of the reference block.

Referring to FIG. 3, if the reference block of the present frame in the input image signal is located in the object's boundary area adjacent to the image area in which the motion scarcely exists, a first motion vector detection unit can detect the MV obtained by motion estimation for the reference block as the final MV of the reference block. In contrast, if the reference block of the present frame in the input image signal is not located in the object's boundary area adjacent to the image area in which a motion scarcely exists, a second motion vector detection unit can detect the median MV obtained by median-filtering the MVs of the reference block and the surrounding blocks as the final MV of the reference block.

In FIG. 3, the first motion vector detection unit may include the motion estimation unit 301, the storage unit 302, the MAE variance value calculator (MAE variance value unit) 303, the comparison unit 304, and the selection unit 306. The second motion vector detection unit may include the motion estimation unit 301, the storage unit 302, the MAE variance value calculator (MAE variance value unit) 303, the comparison unit 304, the median filter 305, and the selection unit 306.

Although the number of surrounding blocks used in calculating the MAE variance value and the number of surrounding blocks used in median-filtering in the aforementioned case are different, the number of surrounding blocks used in calculating the MAE dispersion value and the number of surrounding blocks used in median-filtering may be the same.

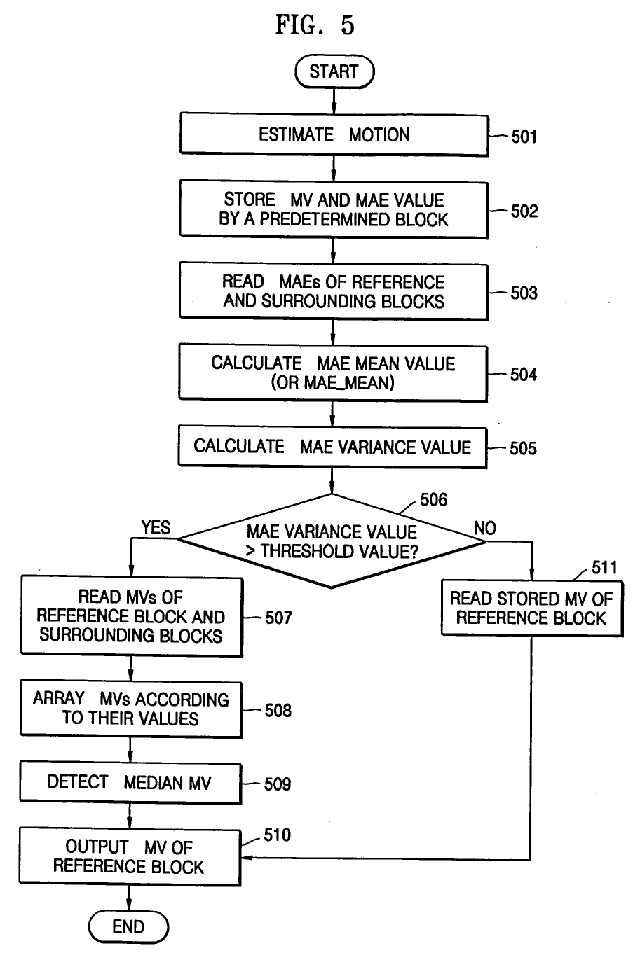

FIG. 5 is a flow chart showing a method of detecting an MV of a reference block according to another embodiment of the present invention.

Referring to FIGS. 3 and 5, the motion estimation can be performed with respect to a predetermined block using a previous frame (field) and a present frame (field) of an input image signals in operation 501. An MV and an MAE value of the present frame with respect the predetermined block can be detected as described in the above motion estimation unit 301.

The detected MV and the MAE value can be stored in operation 502.

The MAE values of the reference block and the surrounding blocks, that exist within a scope (area)set based on the reference block, can be read among the stored MAE values in operation 503. The scope may be set as 5×5 blocks as described in the MAE variance value calculator 303 of FIG. 3. If the scope is set as 5×5 the blocks, the MAE values of twenty five blocks can be read in operation 503.

The mean value (mae_mean) of the MAE values read in operation 504 can be calculated via equation (2).

In operation 505, the MAE variance value of the reference block can be calculated via equation (3) using the MAE values and the mean value (mae_mean) of the MAE values.

The MAE variance value and a predetermined threshold value can be compared in operation 506. The predetermined threshold value can be the same as that defined in the comparison unit 304. If the MAE variance value is larger than the predetermined threshold value, it is determined that the location of the reference block does not belong to an object's boundary area adjacent to an image area in which a motion scarcely exists, and the method proceeds to operation 507.

Operations 507 through 509 relate to a process of median-filtering the MV of the reference block.

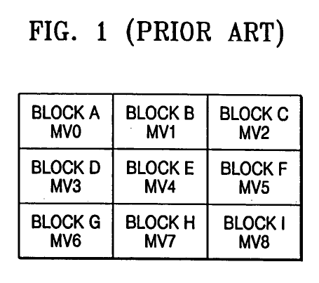

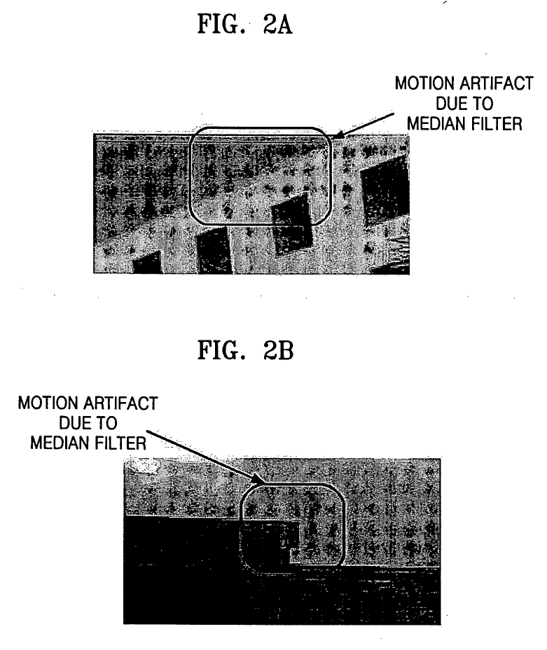

Thus, MVs of the reference block and the surrounding blocks among the stored MVs can be read in operation 507. The MVs of the surrounding blocks are shown in FIG. 1.

The read MVs can be arrayed according to the values of the MVs in operation 508. The MV disposed in the middle of the arrayed MVs can be detected in operation 509. The detected MV can be output as an actual MV (or a final MV) of the reference block in operation 510.

If the MAE variance value is not larger than the predetermined threshold value in operation 506, it is determined that the location of the reference block belongs to the object's boundary area adjacent to the image area in which a motion scarcely exists, and the method proceeds to operation 511.

The MV of the reference block stored in operation 502 can be read in operation 511. Then, the MV read in operation 510 can be output as the actual MV of the reference block.

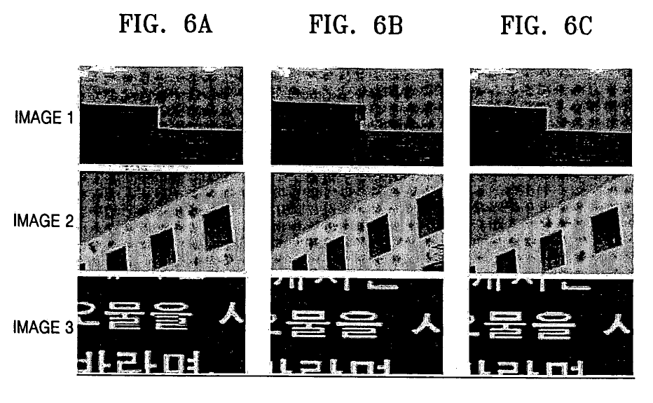

FIG. 6A is a view showing examples of image signals without using a median filter, and FIG. 6B is a view showing examples of the image signals using the median filter. FIG. 6C is a view showing examples of the image signals when the median filter is selectively used according to the present general inventive concept. As is apparent from FIGS. 6A through 6C, the phenomenon of motion artifacts in an object's boundary area adjacent to an image area, in which a motion scarcely exists, can be improved according to as aspect of the present general inventive concept. As described above, by selectively using the median filter to median-filter the MVs detected by the motion estimation according to a correlation between the reference block and the surrounding blocks of the reference block, the embodiment of the present general inventive concept can prevent image artefacts occurring due to the median filter.

Although a few embodiments of the present general inventive concept have been shown and described, it will be appreciated by those skilled in the art that changes may be made in these embodiments without departing from the principles and spirit of the invention, the scope of which is defined in the appended claims and their equivalents.

1. A motion vector detector comprising:
a first motion vector detector unit to perform motion estimation on a reference block of a present frame to detect a first motion vector as a final motion vector of the reference block of the present frame if the reference block of the present frame is located in a boundary area of an object adjacent to an image area in which a motion is less than a value; and
a second motion vector detector unit to perform median-filtering the first motion vector to detect a second motion vector as the final motion vector of the reference block of the resent frame if the reference block is not located in the boundary area of the object adjacent to the image area in which the motion is less than the value.

2. The motion vector detector of claim 1, wherein the first motion vector detector and the second motion vector detector determine whether the location of the reference block belongs to the boundary area of the object adjacent to the area, in which the motion is less that the value by using a mean absolute error variance value of the reference block.

3. A motion vector detector comprising:
a motion estimation unit to estimate motion vectors and mean absolute error values corresponding to the motion vectors with respect to predetermined blocks including a reference block using a previous frame and a present frame;
a storage unit to store the motion vectors and the mean absolute error values estimated by the motion estimation unit;
a mean absolute error variance value calculator to calculate a mean absolute error variance value of the reference block of the present frame using the mean absolute error values;
a median filter to perform median-filtering on the motion vector of the reference block to output a signal as a median-filtering result; and
a selection unit to select one of the signal output from the median filter and the motion vector of the reference block stored in the storage unit and to output the selected one as a final motion vector of the reference block, based on the mean absolute error variance value.

4. The motion vector detector of the claim 3, wherein the mean absolute error variance value calculator calculates a mean value of the mean absolute error values of the reference block and one or more blocks surrounding the reference block stored in the storage unit and calculates the mean absolute error variance value of the reference block using the mean value.

5. The motion vector detector of claim 3, wherein the selection unit selects and sends the one of the motion vector of the reference block stored in the storage unit as the final motion vector of the reference block if the location of the reference block belongs to a boundary area of an object adjacent to an image area in which a motion is less that a value, and the selection unit selects and sends the signal output from the median filter as the final motion vector if the location of the reference block does not belong to the boundary area of the object adjacent to the image area in which the motion is less that the value.

6. The motion vector detector of claim 3, wherein the selection unit selects and sends the signal output from the median filter as the final motion vector of the reference block if the mean absolute error variance value is larger than a predetermined threshold value, and selects and sends the motion vector of the reference block stored in the storage unit as the final motion vector if the mean absolute error variance value is not larger than the predetermined threshold value.

7. The motion vector detector of claim 3, further comprising:
a comparison unit to compare the mean absolute error variance value and a predetermined threshold value and to control the selection unit based on the comparison result.

8. A method of detecting a motion vector, the method comprising:
detecting a motion vector and a mean absolute error corresponding to each motion vector with respect to each predetermined block using a previous frame;
storing the detected motion vector and the detected motion absolute error;
calculating a mean absolute error variance value of a reference block of the present frame;
detecting a median-filtering result on the motion vector of the reference block as a final motion vector of the reference block if a location of the reference block does not belong to a boundary area of an object adjacent to an image area in which a motion is less that a value, based on the mean absolute error variance value; and
detecting the stored motion vector of the reference block as the final motion of the reference block if the location of the reference block belongs to the boundary area of the object adjacent to the image area in which the motion is less that a value.

9. The method of detecting the motion vector of claim 8, wherein the calculating of the mean absolute error variance value comprises:
calculating a mean value of mean absolute error values of the reference block and one or more blocks surrounding the reference block; and
calculating the mean absolute error variance value of the reference block using the mean values.

10. The method of detecting the motion vector of claim 8, wherein:
the detecting of the median-filtering result comprises,
comparing the mean absolute error variance value and a predetermined threshold value, and
detecting the median-filtering result as the final motion vector of the reference block if the mean absolute area variance value is larger than the predetermined threshold value; and
the detecting of the stored motion vector of the reference block as the final motion vector of the reference block comprises,
comparing the mean absolute error variance value and the predetermined threshold value, and
detecting the stored motion vector of the reference block as the final motion vector of the reference block if the mean absolute area variance value is not larger than the predetermined threshold value.

11. A motion vector detector used with an image processing apparatus, comprising:
a median filter to median-filter motion vectors of a reference block and surrounding blocks disposed around the reference block to generate one of the motion vectors as a median motion vector; and
a selection unit to select one of the motion vector of the reference block and the median motion vector as a final motion vector of the reference block.

12. A motion vector detector used with an image processing apparatus, comprising:
a motion vector detecting unit to generate a motion vector of a reference block and generate a median motion vector using motion vectors of the reference block and surrounding blocks disposed around the reference block,
wherein one of the motion vector and the median motion vector is selected as a final motion vector of the reference block.

13. The motion vector detector of claim 12, wherein the motion vector detecting unit generates mean absolute error values corresponding to the motion vectors of the reference block and the surrounding blocks, and the one of the motion vector and the median motion vector is selected as the final motion vector of the reference block according to the mean absolute error values.

14. The motion vector detector of claim 13, wherein the motion vector detecting unit comprises a calculator to generate a mean value from the mean absolute error values, and a comparison unit to compare the mean value with a reference value to generate a signal, and a selection unit to select the one of the motion vector and the median motion vector is selected as the final motion vector of the reference block according to the signal.

15. The motion vector detector of claim 14, wherein the signal comprises a first signal to indicate that the reference blocks not disposed in a boundary area of an image, and a second signal to indicate that the reference block is disposed in a boundary area of the image.

16. The motion vector detector of claim 15, wherein the selection unit selects the motion vector as the final motion vector of the reference block according to the first signal, and selects the median motion vector as the final motion vector of the reference block according to the second signal.

17. The motion vector detector of claim 12, wherein the motion vector detecting unit comprises a storage unit to store the motion vectors of the reference block and the surrounding blocks.

18. The motion vector detector of claim 17, wherein the storage unit further stores mean absolute error values corresponding to the unit blocks, and the motion vector detecting unit selectively outputs the mean absolute error values corresponding to the reference block and the surrounding blocks, the motion vectors corresponding to the reference block and the surrounding blocks, and the motion vector of the reference blocks according to index information of the reference block, the index information indicating which is read among the stored mean absolute error values and the stored motion vectors from the storage unit to be used in generating the final motion vector of the reference block.

19. The motion vector detector of claim 18, wherein the output mean absolute error values is used in determining which one of the motion vector and the median motion vector is generated as the final motion vector.

20. The motion vector detector of claim 19, further comrising a selection unit to prevent the motion vector detecting unit from generating the median motion vector of the reference block as the final motion vector of the reference block to reduce an image artifact occurring in an image due to use of the median motion vector.
